(19) United States
(12) Patent Application Publication
(10) Pub. No.: US 2012/0066282 A1
(43) Pub. Date: Mar. 15, 2012

(54) Whole 1 number method of integer factorization

(76) Inventors: Sherwin Han, Portsmouth, RI (US); David Zhu, Hong Kong (CN)

(21) Appl. No.: 13/190,646

(22) Filed: Jul. 26, 2011

Related U.S. Application Data
(60) Provisional application No. 61/403,337, filed on Sep. 14, 2010.

(51) Int. Cl. G06F 7/552; G06F 7/42

(52) U.S. Cl. 708/605; 708/680

(57) ABSTRACT

Disclosed is a method for factoring integers by squaring computation time. The present invention uses binary numbers to process invert function of multiplication as factorization. Inverse method of integer factorization uses a diamond expansion form to arrange the digit positions of 1-numbers and 0-numbers subtracted from the product number P and its complement number No. The complement number N₀ is the difference between the product number P and the square of the whole-1-number 1ₙ². The square of the whole-1-number 1ₙ² equals to the number of that first n-1 digits are 1s, followed by n 0s, and ended by 1.

7

### FIELD OF THE INVENTION

The present invention relates generally to solving the factoring integers, and more specifically to solving factoring integers in polynomial time.

### BACKGROUND OF THE INVENTION

Integer factoring is a problem that has both academic and practical significance. In the industry domain the methodology of the solution can be used to many purposes. There is no known polynomial-time efficiency solution of factorization. The present invention provides such a polynomial, more accurately, squaring-time efficiency methodology of solving integer factorization.

### SUMMARY OF THE INVENTION

The present invention of integer factorization method employs a diamond expansion form of multiplication as its platform. The diamond expansion form contains two multiplies M₁, M₂ and whole-0-numbers 0ₙ. The whole-0-numbers determine the digit positions of the two multiplies. The 0-number N₀ is the sum of the whole-0-numbers 0ₙ, which is the difference between the product and the square of the whole-1-numbers 1ₙ, defined by N₀=(2ⁿ−1)²−P. The square of 1ₙ is a number contains 2ₙ digits, in which the first n-1 digits are 1s, followed by n 0s, and ended by 1.

The inverse method of integer factorization applies a method of subtraction from the given product P and N₀ one digit by one digit, starting from the lowest digit to the highest digit. The 1s and 0s are added into the diamond expansion form one digit by one digit starting from the lowest digit position to the highest digit position.

The subtraction method includes the method of n-digit whole-0-number 0ₙ subtraction. That is, each time a whole-0-number 0ₙ is subtracted from zero-number N₀ and being added to the diamond expansion form. The 0ₙ is an n-digit whole-0-number.

### BRIEF DESCRIPTION OF THE DRAWINGS

A more complete understanding of the invention will be readily appreciated as the same becomes better understood by reference to the following detailed description when considered in conjunction with the accompanying drawing:

FIG. 1 Diamond expansion form of whole-1-number

FIG. 2 Diamond expansion form of multiplication

FIG. 3 Factorization: N₀=(2ⁿ−1)²−P

FIG. 4 Factorization: Subtraction

FIG. 5 Factorization: Ordinal Positions

### DETAILED DESCRIPTION OF THE INVENTION

In the present invention we use binary numbers for factorization. For better understanding, let us denote the symbols used in the description as followings:
1. All the numbers indicated in this application document are binary numbers except the digit positions.
2. 1-number denoted N₁ is the ordinal of 1, such as the ordinal of 1 in 10011 is the 4 number itself, denoted by 10011₁.
3. 0-number denoted N₀ is the ordinal of 0, such as the ordinal of 0 in 00110 is 11001, denoted by 11001₀.
4.Whole-1-number denoted 1ₙ is the number in which all the digits are is, such as 1111, denoted by 1₄.
5. Whole-0-number denoted 0ₙ is the number in which all the digits are 0s, such as 00000, denoted 0₅.
6. Diamond expansion form is a form being used to process multiplication and factorization.
7. Factorization is an inverse function of multiplication in a diamond expansion form.

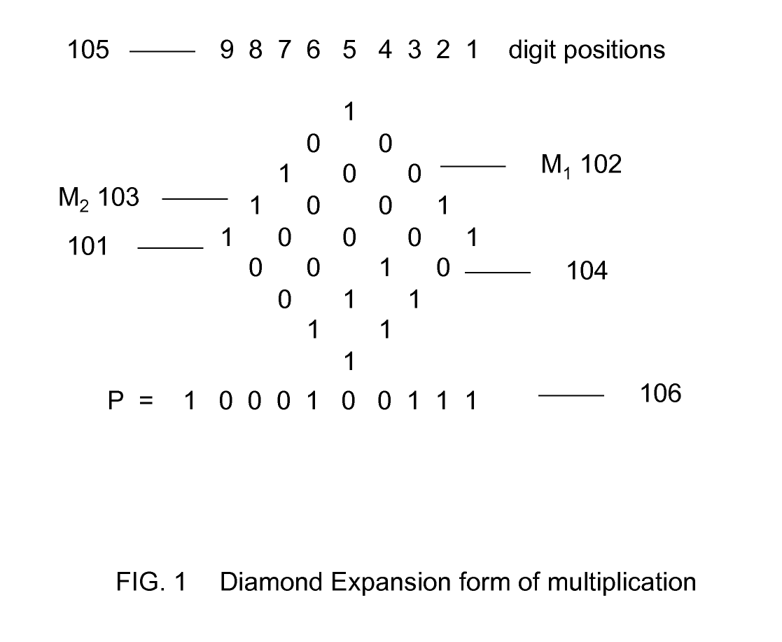

Referring FIG. 1, the present invention of integer factorization method employs a diamond expansion form 101 of multiplication as its platform. The diamond expansion form 101 contains two multiplies: M₁=10011 102, and M₂=11101 103. The diamond expansion form 101 contains also whole-0-numbers 104. Two multipliers 102 and 103 are in a perpendicular position respectively. Both multipliers M₁ and M₂ are n-digit numbers. In case any multiplier is shorter then n digits, 0s are used in front of the multiplier. The whole-0-numbers 104 are n digits whole-0-numbers. There may be multiple, single, or no whole-0-numbers 104 in the diamond expansion form 101. If no whole-0-number is in the diamond expansion form, then the form is a whole-1-number diamond expansion. The whole-0-numbers 104 provide the complementary infrastructure for 1-numbers. Based on this complementary infrastructure, all the left-leaning numbers are the multiplier M₁ 102 at variant positions 105, and all the right-leaning numbers are the multiplier M₂ 103 at variant positions 105.

The product of the two multipliers M₁ 102 and M₂103 is the sum of all the 1s in each column of the diamond expansion form. From the inverted perspective, the multipliers are the addends organized by the whole-0-number structure.

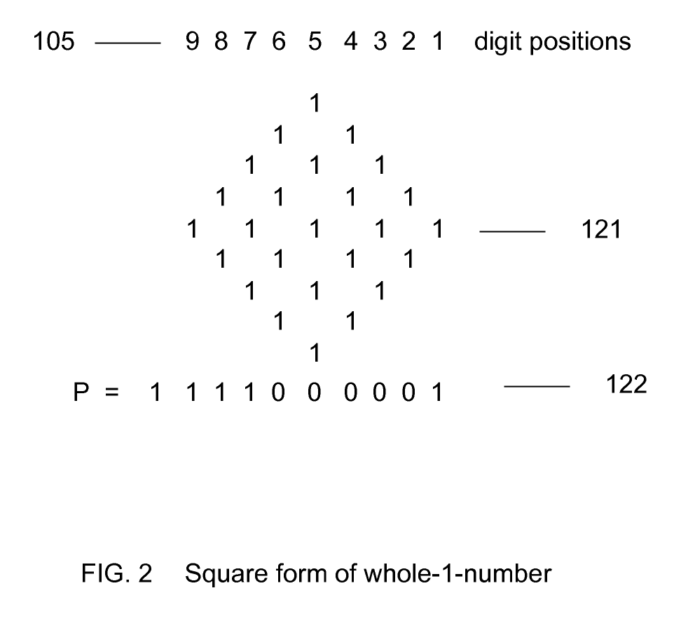

Referring FIG. 2, the inverse method of integer factorization applies a method of (1ₙ)² 121. The square of 1ₙ is a number containing 2 n digits, in which the first n-1 digits are 1s, followed by n0s, and ended by 1. The square of 1₅ 121 is 1111000001 122. 1ₙ²=2ⁿ×1ₙ₋₁+2×0ₙ+1 is its general mathematical formula.

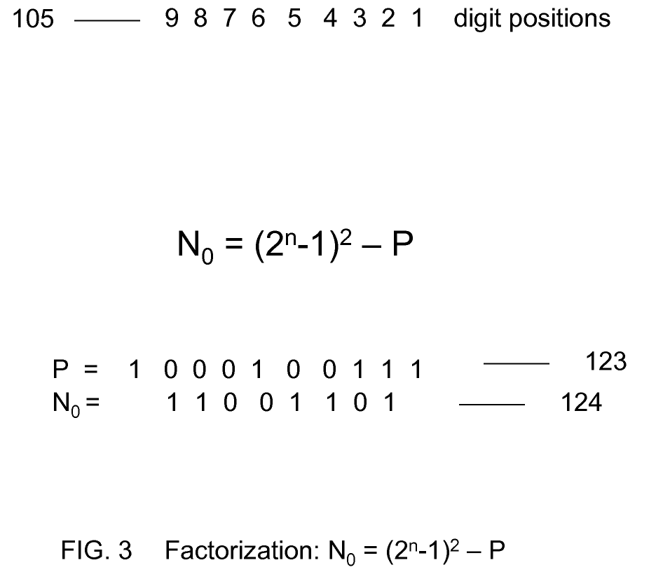

Referring FIG. 3, the inverse method of integer factorization applies also a method of zero-number N₀ 124, where N₀=(2ⁿ−1)²−P 123.

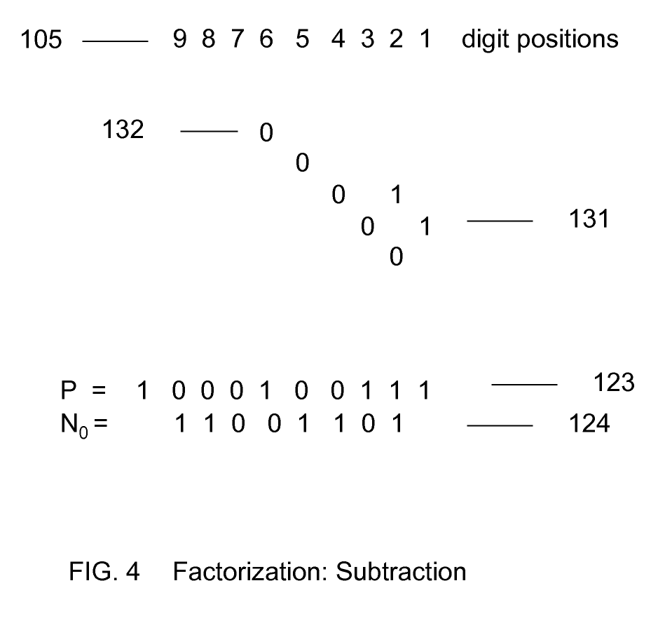

Referring FIG. 4, the inverse method of integer factorization applies a method of subtraction from the given product P 123 and N₀ 124 one digit by one digit, starting from the lowest digit to the highest digit, and adding them into the diamond expansion form one digit by one digit starting from the lowest digit position 131 to the highest digit position.

Referring FIG. 4 again, the subtraction method includes the method of n-digit zero-number 0ₙ subtraction. That is, each time a zero-number such as 0ₙ 132 is subtracted from zero-number N₀ 124 and added to the diamond expansion form, the 0ₙ 132 is an n-digit whole-zero-number.

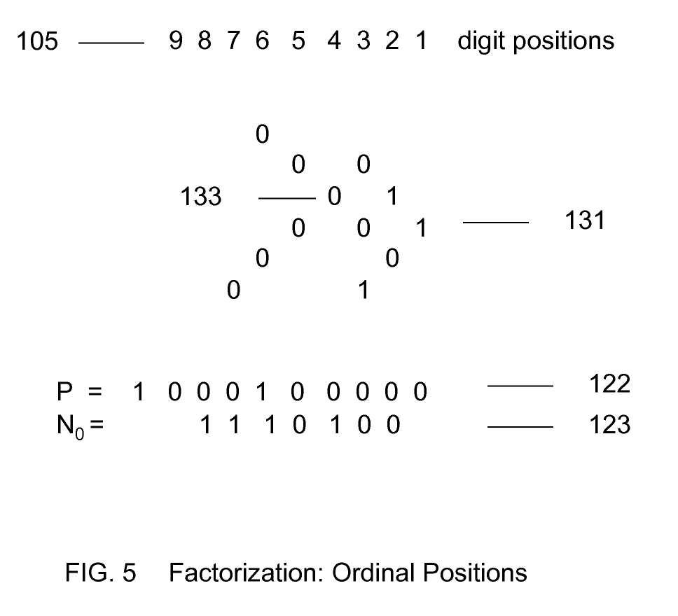

Referring FIG. 5, the subtraction method includes the method of intersection 133 process, where the digit of intersection is only processed once.

The present invention employs a trial-error method in a range at most squaring computation steps. The trial-error method is a standard method. We do not discuss it specifically.

Although the present invention has been described in simple terms, this invention provides a very clear cut solution to a well-known problem for which there has been no polynomial solution until now. Any modifications or alterations to this invention should be included within the scope of this invention.

What are claimed:

1. A method of integer factoring that is a reverse function of multiplication.

2. The method of claim 1, wherein the integer factoring method applies a diamond expansion form of multiplication as the form of factorization.

3. The method of claim 2, wherein the integer factoring method applies a method of complement 0-numbers as its reverse means.

4. The method of claim 3, wherein the complement 0-number comes from the square of the whole-1-number.

5. The method of claim 4, wherein the square of the whole-1-number equals to the a number in that first n-1 digits are 1s, followed by n 0s, and ended by 1.

6. The method of claim 1, wherein the integer factoring includes a reposition method of zero-numbers and 1-numbers.
